(19) United States
(12) Patent Application Publication
(10) Pub. No.: US 2019/0258970 A1
(43) Pub. Date: Aug. 22, 2019

(54) Practical Optimization-Free Economic Load Dispatcher Based on Slicing Fuel-Cost Curves of Electric Generating Machines

(71) Applicants: Ali Ridha Ali, Halifax (CA); Mohamed El-Aref El-Hawary, Halifax (CA)

(72) Inventors: Ali Ridha Ali, Halifax (CA); Mohamed El-Aref El-Hawary, Halifax (CA)

(73) Assignee: Ali Ridha Ali, Halifax, NS (CA)

(21) Appl. No.: 15/899,320

(22) Filed: Feb. 19, 2018

(51) Int. Cl. G06Q 10/04; H02J 3/00; G06Q 50/06; G06F 17/11; H02J 3/46

(52) U.S. Cl. CPC G06Q 10/04; H02J 3/006; G06F 2217/78; G06F 17/11; H02J 3/46; G06Q 50/06

(57) ABSTRACT

Nowadays, there are different techniques used to effectively optimize the power settings of electric generating machines so the system load can be met with the lowest possible operating cost. The main problem associated with these techniques is: they are optimization-dependents. This means slow processing speed, special software, and highly experienced crew. In many power plants, the set-points assigned by automation centers for generating machines are in discrete form. Thus, the current continuous optimization algorithms should be modified to be in a combinational mode. This invention is a new technique that can practically solve discrete economic load dispatch (ELD) problems without using any optimization algorithm. It has the ability to find all the possible ELD solutions and satisfy all the associated design constraints quickly and smoothly. Also, it can be used even with continuous ELD problems with a negligible error.

### TECHNICAL FIELD

Embodiments are generally related to electric power systems operation, and more specifically, in economic load dispatch and unit commitment subjects.

### BACKGROUND OF THE INVENTION

Economic load dispatch (ELD) can be defined as: a technique used to schedule the output of committed generating machines to meet the required load demand at the lowest production cost.

Currently, there are two approaches can be used to solve ELD problems:
Analytical Approach: mainly used if the given system is small and has many simplifications, such as: neglecting network losses and generators' limits. Thus, it cannot be used for practical ELD problems.
Numerical Approach: mainly used to solve more complex systems.

The numerical approach itself is divided into four main streams:
Traditional Optimization Algorithms: such as Newton-Raphson algorithm, lambda-iteration algorithm, linear programming (LP), non-linear programming (NLP).
Modern Optimization Algorithms: come with many names such as metaheuristic, stochastic, evolutionary, and nature-inspired algorithms. Such these algorithms are: genetic algorithm (GA), ant colony optimization (ACO), particle swarm optimization (PSO), biogeography-based optimization (BBO), evolutionary algorithm (EA), etc.
Artificial Intelligence Algorithms: such as artificial neural networks (ANNs), support vector machines (SVMs), and fuzzy systems (FS).
Hybrid Optimization Algorithms: could be designed by hybridizing between different algorithms selected from the preceding three streams.

To be able to solve ELD problems in any n-dimensional optimizer:
Transforming the realistic problem into a mathematical model.
If our goal is to reduce the total cost Σᵢ₌₁ⁿCᵢ of the power produced from n generating machines P_{T}=Σᵢ₌₁ⁿPᵢ, then the objective function can be modelled as follows:

$$OBJ = min {\sum }_{i = 1}^{n} {C}_{i} ( {P}_{i} ) \qquad Eq . ( 1 )$$

where Pᵢ is the real power (i.e., the independent variable) of the ith unit, and Cᵢ is the cost function (i.e., the dependent variable) of the ith unit.

From the literature, based on the machine type and modelling used, Cᵢ could be represented by one of the following equations:
Cubic Polynomial Equation:

Cᵢ(Pᵢ)=aᵢ+bᵢPᵢ+cᵢPᵢ²+dᵢPᵢ³ Eq.(2)
where aᵢ, bᵢ, cᵢ, and dᵢ are called the regression coefficients.
Quadratic Polynomial equation:

Cᵢ(Pᵢ)=aᵢ+bᵢPᵢ+cᵢPᵢ² Eq.(3)
Cubic/Quadratic+Sinusoidal:

\tilde{C}ᵢ(Pᵢ)=Cᵢ(Pᵢ)+|eᵢ×sin[fᵢ×(Pᵢ^{min}−Pᵢ)]| Eq.(4)
where Pᵢ^{min} is the minimum allowable real power supplied by the ith generator.
Or even a linear equation (for wind turbines) or any other equation.

The objective functions given in Eqs.(2)-(4) should be minimized with satisfying some design constraints, such as:
Active Power Capacity Constraint:

Pᵢ^{min}≤Pᵢ≤Pᵢ^{max} Eq.(5)
where Pᵢ^{max} is the maximum allowable real power supplied by the ith generator.
Active Power Balance Constraint:

P_{T}−P_{D}−P_{L}=0 Eq.(6)
where P_{T} and P_{D} are denoted for the total power generated by n generators and load demand, respectively. The symbol P_{L} stands for the network losses.
Also, based on the type and operational philosophy of power stations, there are many possible constraints, such as: generators ramp rate limits, prohibited operating zones, emission rates, spinning reserve, line flow, hydro-water discharge limits, reservoir storage limits, water balance equation, network security, etc.

The main challenges faced with existing ELD optimization techniques are: the long time consumed for getting the final results and the complexity to design, implement, execute, and modify such these algorithms in real world ELD problems.

Also, in many electric power stations, the corresponding operation departments receive strict commands from their energy dispatching centers (automation centers or system control centers) to adjust generating machines at some desired set-points. Many times, these commands come in discrete forms; such as set the real power of the ith unit to Pᵢ=75 MW instead of Pᵢ=75.32741 MW. This mechanism can be described in 10 of FIG. 1, where the discrete commands are sent from 15 to 14 to met the load demand measured at 11.

This crucial note means all the known optimal solutions presented in the literature are theoretically feasible settings, but, practically, they are not. For example, based on the literature, all the records tabulated in tables of FIG. 3 and FIG. 4 for the IEEE 3-unit ELD problem are infeasible from this practical perspective.

Two approaches can be applied here to overcome the preceding technical issue:
Using combinational optimization algorithms (COAs), or
Using some other optimization-free alternatives.

This invention proposes a new optimization-free (but not a modeling-free) technique, which is based on sliced fuel-cost curves (SFCC) of generating machines. The slicing process will be discussed in more details later in the next section.

Comparing with the brute-force method (also known as exhaustive search method), the latter one cannot be used in solving ELD problems because of the computing memory issue as the problem dimension or/and the step-size resolution of Pᵢ increases. In the opposite side, SFCC employs some topologies inspired from realistic electric power systems, so the corresponding ELD problems are solvable even with large systems.

### BRIEF DESCRIPTION OF THE DRAWINGS

FIG. 1 depicts the flowchart of essential parts of a general electric power system.

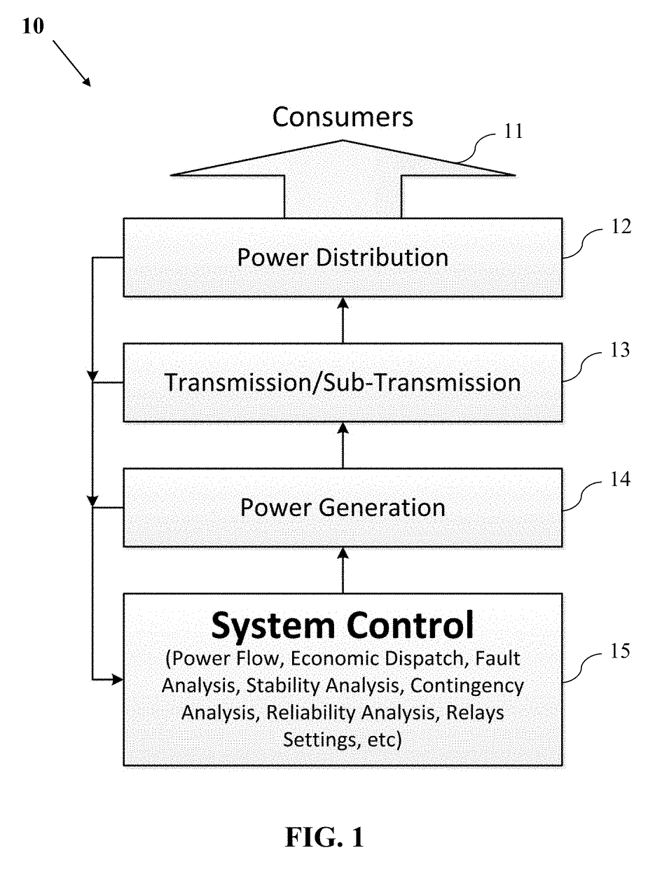

FIG. 2 depicts the flowchart of the main stages of the SFCC technique.

FIG. 3 shows some optimization-based solutions to the IEEE 3-unit ELD problem using three versions of continuous biogeography-based optimization algorithm presented in the literature.

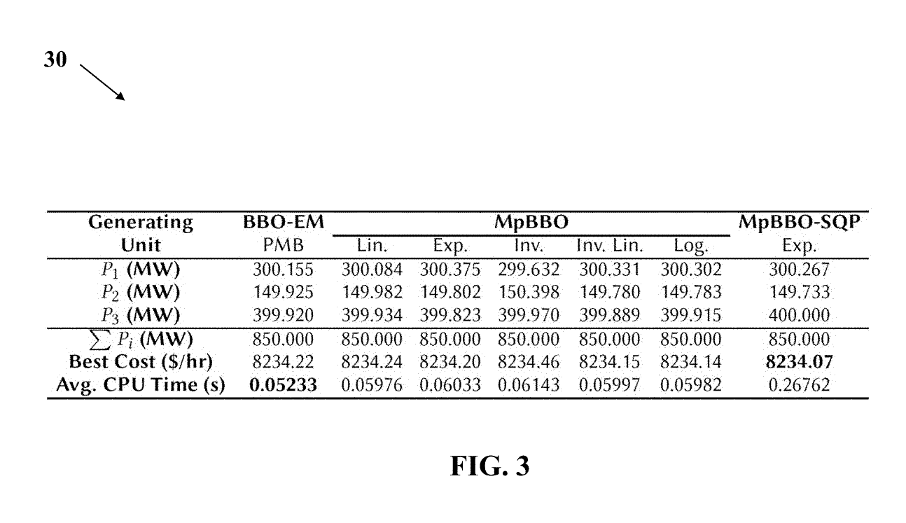

FIG. 4 shows the population size and iteration numbers used to solve the IEEE 3-unit ELD problem through different continuous optimization algorithms presented in the literature.

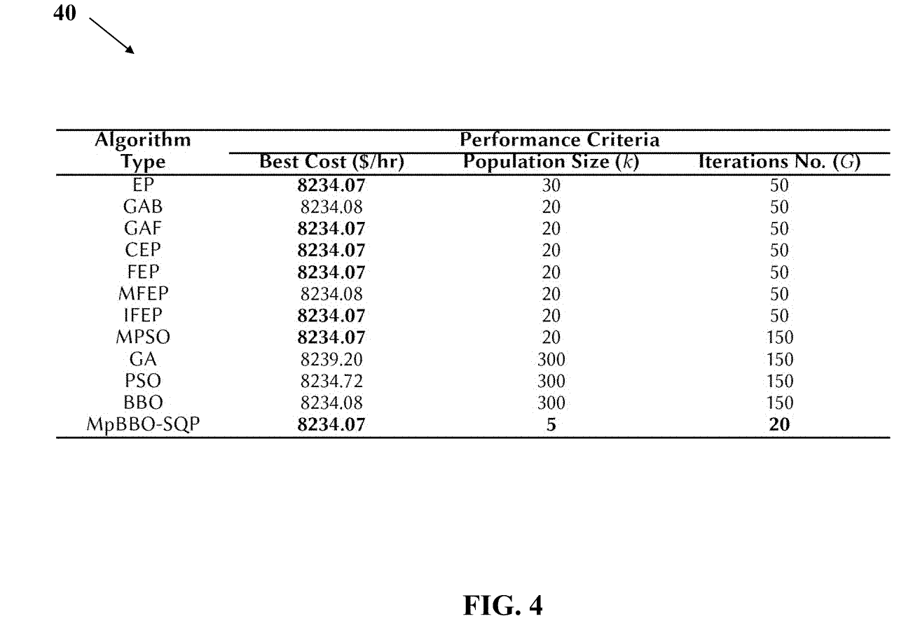

FIG. 5 gives a quick comparison between combinational optimization algorithms and the invention (i.e., the SFCC technique).

FIG. 6 shows the solutions to the IEEE 3-unit ELD problem using a combinational version of the MpBBO optimization algorithm and the invention (i.e., the SFCC technique) with different slicing resolutions.

FIG. 7 shows all the feasible solutions to the IEEE 3-unit ELD problem when it is solved by the invention (i.e., the SFCC technique) and the slicing resolution is set with 5 MW.

FIG. 8 shows all the feasible solutions to the IEEE 3-unit ELD problem when it is solved by the invention (i.e., the SFCC technique) and the slicing resolution is set with 2 MW.

FIG. 9 shows all the feasible solutions to the IEEE 3-unit ELD problem when it is solved by the invention (i.e., the SFCC technique) and the slicing resolution is set with 1 MW.

FIG. 10 shows the first 10 best ever solutions obtained for the IEEE 3-unit ELD problem when it is solved by the invention (i.e., the SFCC technique) with the slicing resolution of 1 MW.

FIG. 11 shows the solutions obtained for the IEEE 40-unit ELD problem when it is solved by using our combinational version of the MpBBO optimization algorithm at different slicing resolutions and without considering the practical equality constraint, i.e. Eq.(9), associated with each power station.

FIG. 12 illustrates a simplified arrangement of generating units in each power station, and how these power stations can be organized to act as local ELD solvers and their automation center as a global ELD solver. This arrangement is very essential to avoid computing memory issue when the SFCC invention is applied to solve high-dimensional ELD problems.

FIG. 13 shows the first extension to make our invention (i.e., the SFCC technique) applicable to float load demands.

FIG. 14 shows the second extension to make our invention (i.e., the SFCC technique) applicable to float load demands.

FIG. 15 shows the third extension to make our invention (i.e., the SFCC technique) applicable to float load demands.

### DETAILED DESCRIPTION

To be able to employ our invention (i.e., the SFCC technique) in solving realistic ELD problems, the following steps should be taken:

First, the real power set-points of generating units must be changed in discrete values, so each ith unit will have the following independent vector Pᵢ:

Pᵢ=[0, Pᵢ^{min}, P_{i,1}, P_{i,2}, . . . , Pᵢ^{max}] Eq.(7)

Then, the corresponding cost is calculated for each element of the Pᵢ vector as follows:

Cᵢ=[Cᵢ(0), Cᵢ(Pᵢ^{min}), Cᵢ(P_{i,1}), Cᵢ(P_{i,2}), . . . , Cᵢ(Pᵢ^{max})] Eq.(8)

where Cᵢ(0) is the operating cost of the ith unit when it is operated under the fully speed no load (FSNL) condition.

If the ELD problem contains n generating units, then there are n independent vectors stored in P matrix and n dependent vectors stored in C matrix. By doing a pairwise or element-by-element summation between the matrices P and C the entire search space of the ELD problem can be obtained.

After that, all the design constraints of the ELD problem are implemented as sequential filters to those solutions that occupy the entire search space. Thus, any solution fails to pass all these filters is rejected (i.e., considered as infeasible solution for the given load demand P_{D}).

The last stage is to sort the remaining solutions, which represent the feasible search space. Therefore, the best ever solution is the one that scores the lowest operating cost.

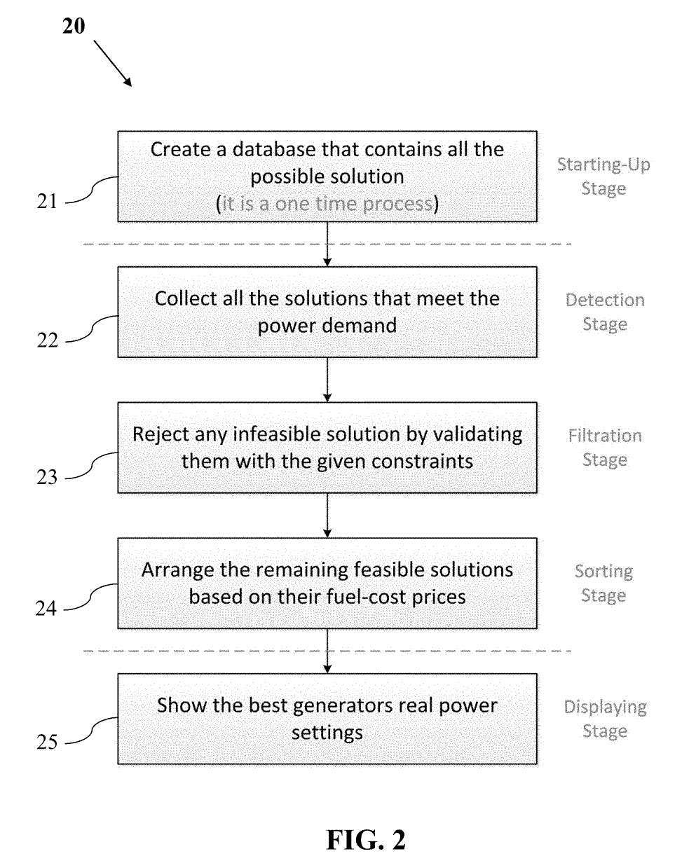

The operational steps presented in Paragraphs [030]-[034] are the core of this invention, which are described through the blocks 21 to 25 of FIG. 2.

The first stage (i.e., 21 of FIG. 2) consumes a considerable CPU time to create the entire database. The SFCC invention uses a different structure, so it can pass that stage easily. Once the database is successfully created, then that stage is always bypassed for any new load demand. In the opposite side, existing optimization algorithms must be run from the beginning for any change detected in the load demand.

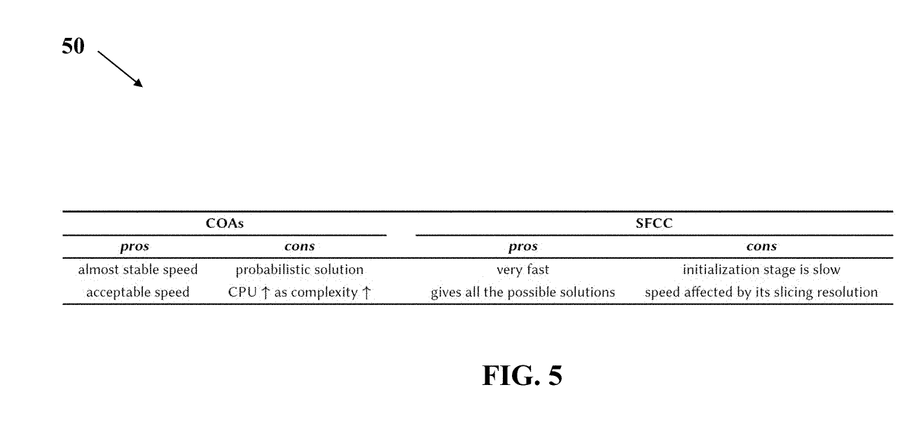

As said before in Paragraph [011], the other approach is to use combinational optimization algorithms (COAs). The main pros and cons of each approach are listed in FIG. 5.

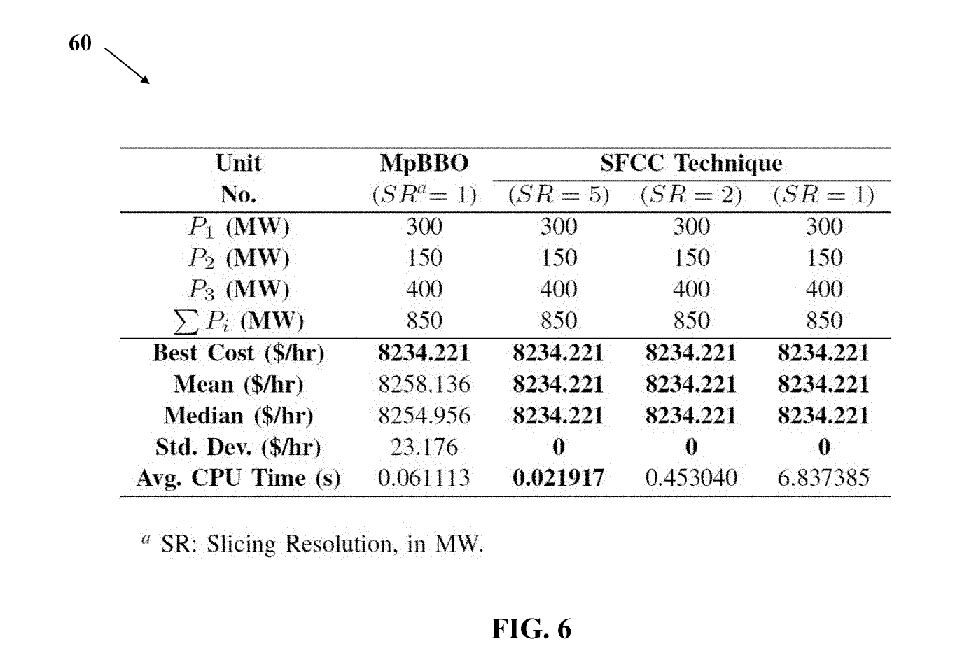

To compare the performance of COAs with that of the SFCC invention, we have modified our MpBBO algorithm (a continuous meta-heuristic optimization algorithm presented before in the literature as a journal paper) to act as an evolutionary combinational optimization algorithm and then compared with SFCC (i.e., our invention) in solving the IEEE 3-unit ELD problem. The results are shown in FIG. 6.

By linking FIG. 5 with FIG. 6, it is obvious that most of the time COAs does not necessarily converge to the best ever solution, because they are probabilistic based searchers. While the SFCC invention can score the same best solution every time it is executed. Also, it shows that the slicing resolution is the key to reduce the CPU time of SFCC.

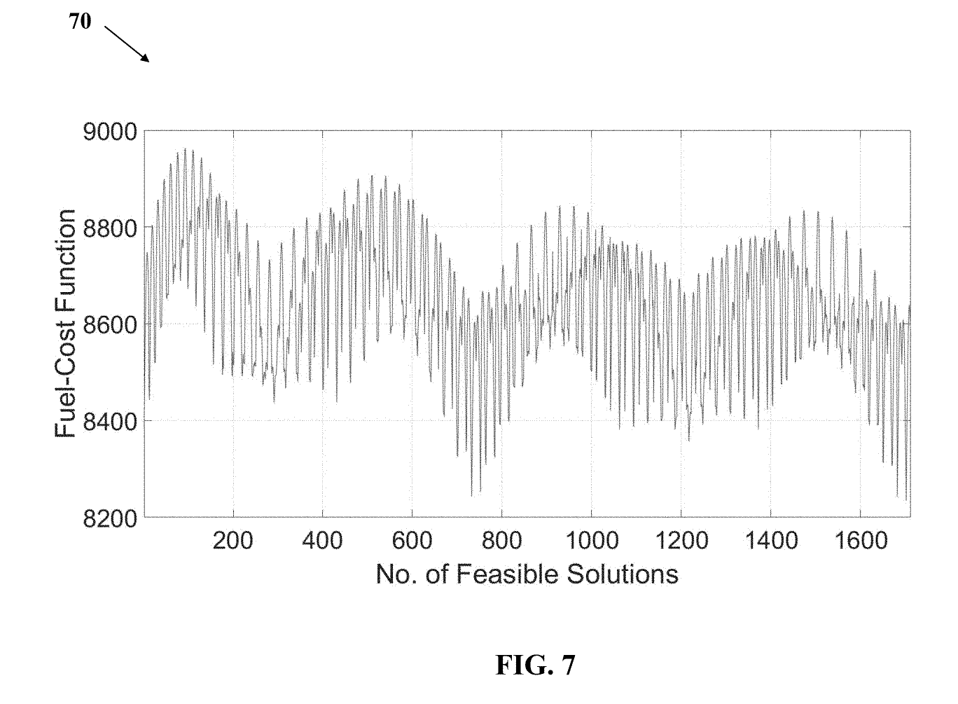

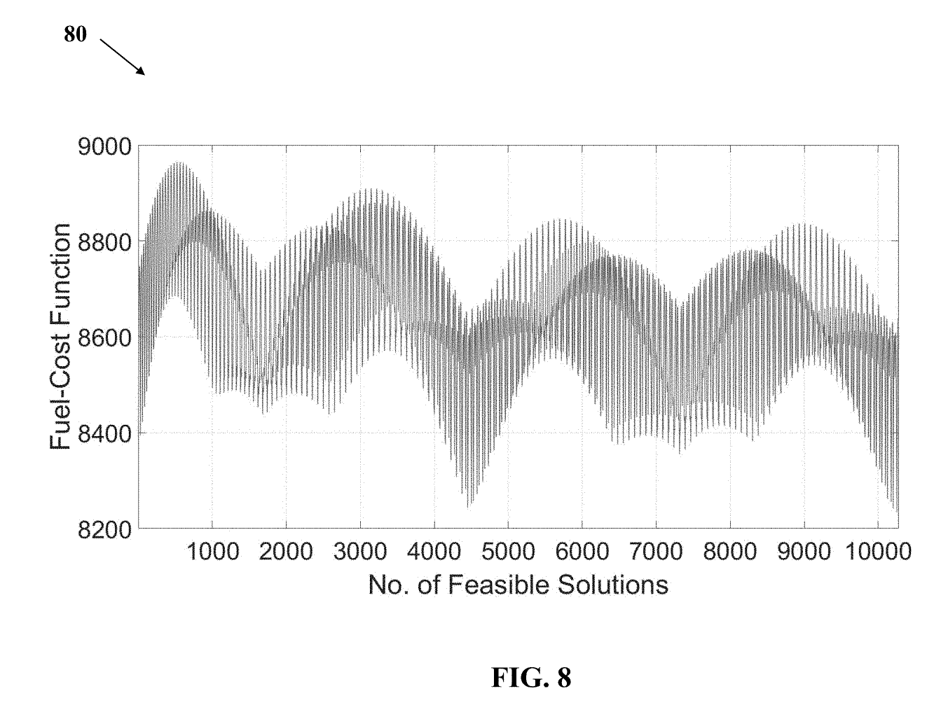

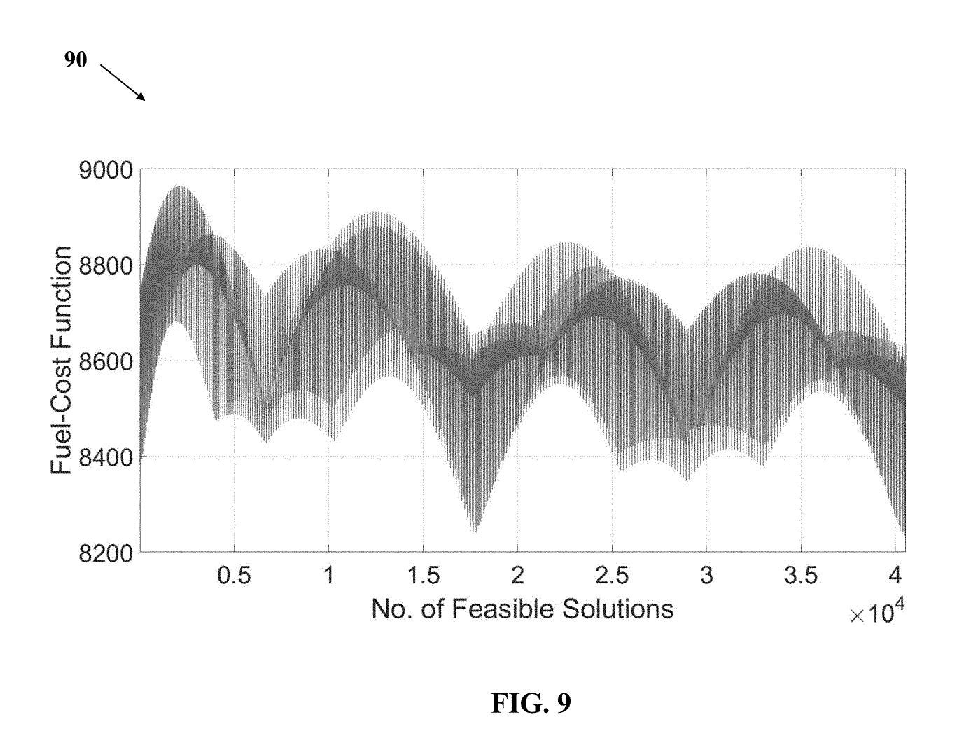

The other fact about the slicing resolution is: as the slicing resolution increases the number of feasible solutions increases too. This can be clearly seen by plotting all the extracted feasible solutions in FIG. 7, FIG. 8, and FIG. 9; where their slicing resolutions are set as ΔPᵢ=5 MW, 2 MW, and 1 MW, respectively.

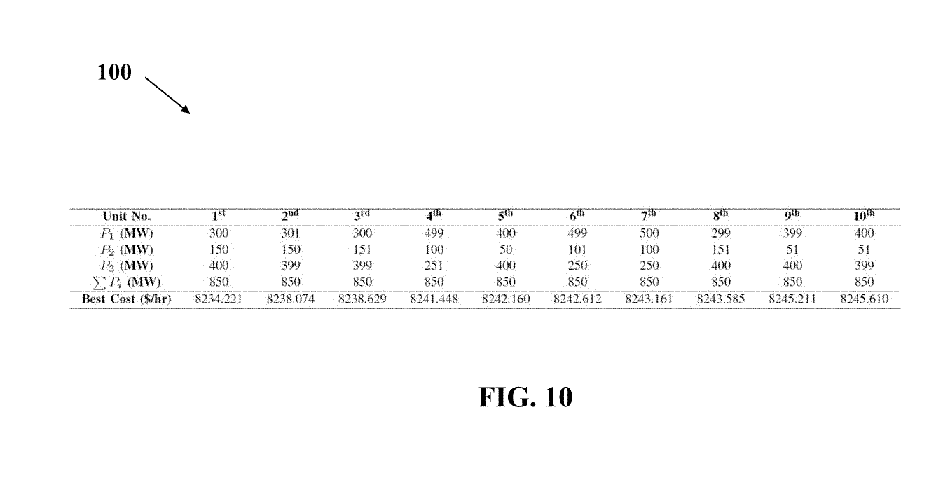

Also, SFCC can show the second, third, fourth, etc, best solutions while COAs cannot. For example, the first 10 best ever solutions obtained by this invention for the IEEE 3-unit ELD problem are presented in FIG. 10.

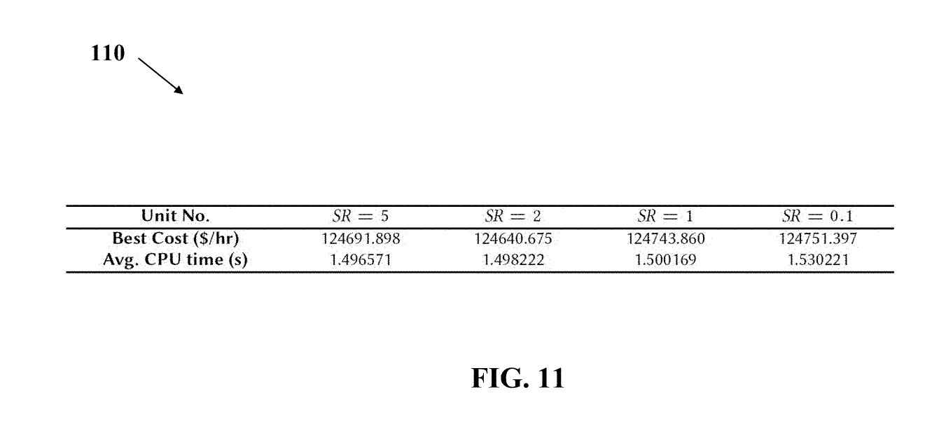

By referring to the pros of COAs presented in FIG. 5, the speed is almost constant for any slicing resolution. The preceding evolutionary combinational optimization algorithm is also tested to solve the IEEE 40-unit ELD problem with different slicing resolutions. The global optimal costs of these 40 discrete settings are shown in FIG. 11 for all the four slicing resolutions. These four solutions have almost same CPU time. Also, the operating costs are almost equal where the lowest cost is 124640.675 $/hr at ΔP=2 MW and the highest cost is 124751.397 $/hr at ΔP=0.1 MW; i.e., the maximum difference is only 110.722 $/hr. It can be seen that increasing the slicing resolution to 1 MW and 0.1 MW ruin the best solution that is obtained by the 2 MW slicing resolution.

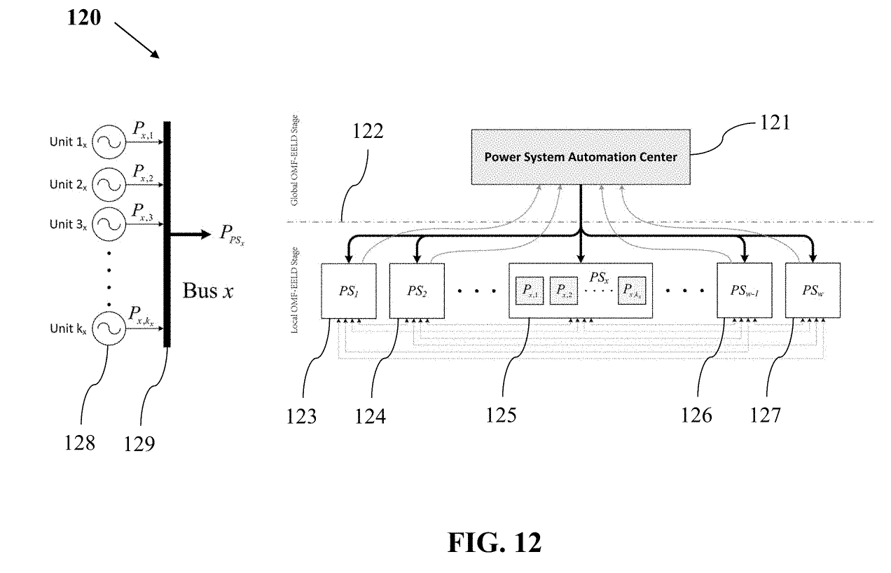

Because the starting-up stage shown in 21 of FIG. 2 consumes more CPU time as the slicing resolution or/and number of generating units increases, so it is important to select a compromise slicing resolution and decompose generating units to their power stations. This configuration is shown in FIG. 12. Thus, for the xth power station PSₓ shown in 125 of FIG. 12, there are k generating units (i.e., k out of n units distributed among w power stations; from 123 to 127). These k units shown in 128 are synchronized and connected to a one common busbar 129 where the total power output of the xth power station is transferred to the grid.

This real world arrangement of generating units in power stations reveals a hidden fact that each power station has an equality constraint that needs to be satisfied to have a feasible ELD solution. Therefore, with w power stations shown in FIG. 12, there are w equality constraints as follows:

$$\begin{matrix}{P}_{{PS}_{1}} = {P}_{1 , 1} + {P}_{1 , 2} + … + {P}_{1 , {k}_{1}} \\ {P}_{{PS}_{2}} = {P}_{2 , 1} + {P}_{2 , 2} + … + {P}_{2 , {k}_{2}} \\ ⋮ \\ {P}_{{PS}_{x}} = {P}_{x , 1} + {P}_{x , 2} + … + {P}_{x , {k}_{x}} \\ ⋮ \\ {P}_{{PS}_{w}} = {P}_{w , 1} + {P}_{w , 2} + … + {P}_{w , {k}_{w}}\end{matrix} \qquad Eq . ( 9 )$$

In the literature, satisfying the power balance equality constraint, given in Eq.(6), in optimization algorithms is not an easy task. Now, imagine if w additional equality constraints are added to the previous one! Definitely, it will be a very challenging task and optimization algorithms will require some special sub-algorithms and a significant amount of CPU time. In the opposite side, SFCC can deal with these hidden practical equality constraints (and any other equality, inequality, or side constraint) easily and smoothly with an ignorable efforts from their programmers and almost same CPU time; which is one of its key features.

By returning back to FIG. 12, to be able to apply SFCC in solving high-dimensional ELD problems, we have proposed two levels in this invention and we called them global and local ELD solvers. For the global level, there is only one ELD solver, which deals with the total power received from each power station as a one virtual generating unit (P_{PS}_{ₓ}). Thus, this level deals with a w-dimensional ELD problem. For the local level, there are w ELD solvers, where each one of them is responsible to minimize the operating cost of its power station by solving its internal k-dimensional ELD problem. Thus, the local ELD solvers find the economical settings of the corresponding power stations to meet the power required from the automation center 121. The global ELD solver is responsible to find the best total power generated from each power station so that the load demand can be satisfied with the minimum power losses dissipated in the network.

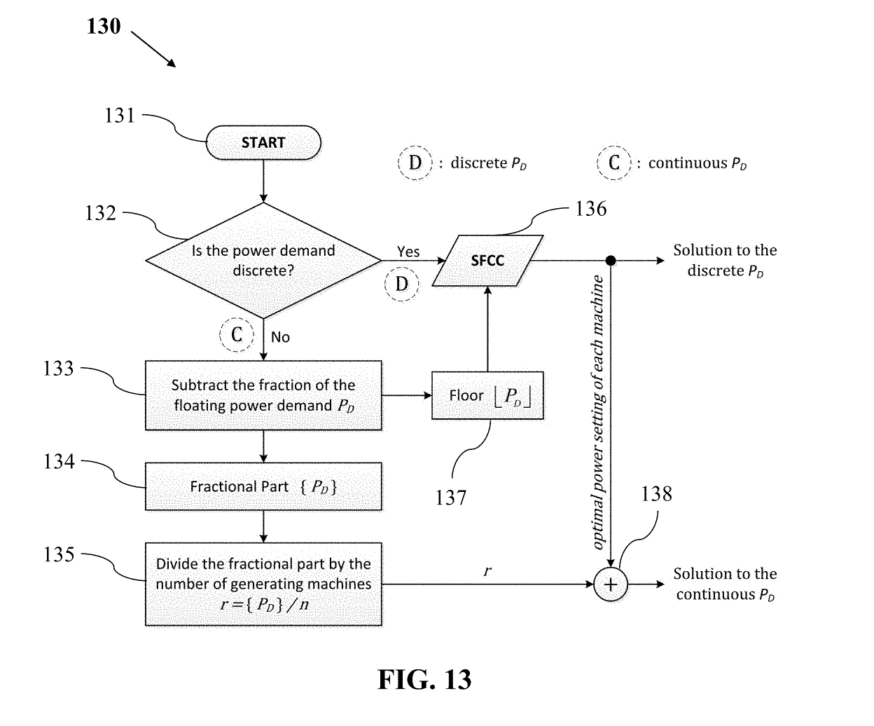

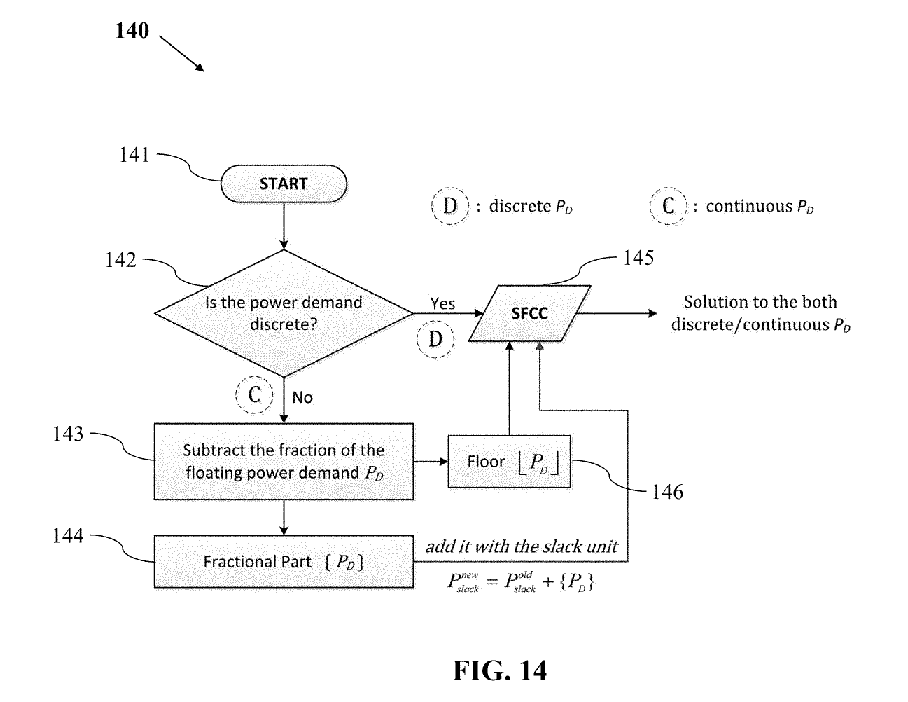

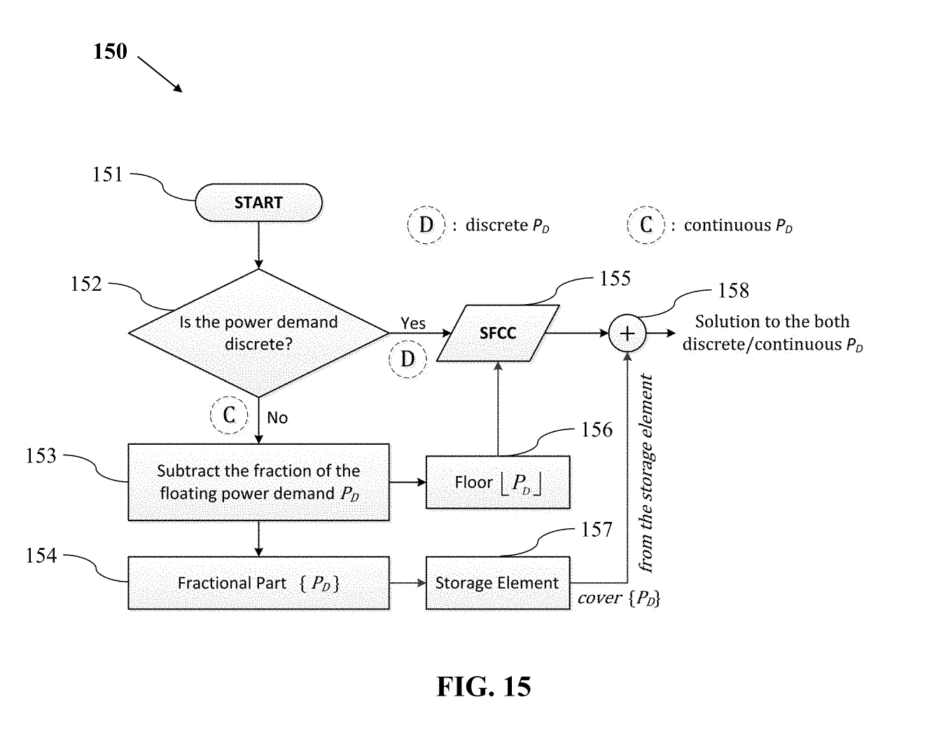

There is one remaining issue that will be faced when this SFCC invention is applied to solve real world ELD problems. This technical issue is concentrated in the nature of the load demand P_{D} described in Eq.(6). P_{D} varies based on the power usage profile of customers and end-users. Most of the time, P_{D} is a float value not a discrete. Therefore, the main question that must be raised here is: how can we cover the remaining fractional part pf the power if these n generating units are operated with discrete set-points? In this invention, three possible approaches are suggested to practically solve that technical issue. These three approaches are presented in FIG. 13, FIG. 14, and FIG. 15.

In FIG. 13, after starting the algorithm in 131, the block 132 will check whether the load demand P_{D} is float or discrete. If it is discrete, then it will be smoothly processed in 136 without any problem. But, if P_{D} is a float value, then the fractional part should be subtracted in 133, and then the remaining discrete value in 137 is processed in 136. The remaining value of P_{D} (i.e., the fractional part, which is less than the slicing resolution) in 134 is divided by n (i.e., the number of generating units) in 135. The incremental value r calculated in 135 is added to the setting of each unit obtained by SFCC in 136. Thus, each unit should provide a power equals the discrete setting Pᵢ obtained in 136 plus the incremental value r obtained in 135.

In FIG. 14, the same thing happens if the load demand P_{D} is discrete, where the algorithm is started in 141. The value of P_{D} is checked in 142, and then dispatched in 145 to have optimal discrete set-points for all n generating units. If P_{D} is not discrete, then the fractional part {P_{D}} is extracted in 143. The discrete value of P_{D} obtained by floor math function in 146 is sent to 145. The remaining part of P_{D} extracted in 143 and saved in 144 is added to the slack generating unit (i.e., the biggest unit) to cover the remaining power instead of sharing that fractional part by n units as seen in FIG. 13.

In FIG. 15, again, the same thing happens if the load demand P_{D} is discrete. But, when P_{D} is float/continuous, then the remaining fractional part of power {P_{D}} in 154 is covered by a storage element 157. A group of centralized or distributed storage elements can also be used to share that fractional power {P_{D}} in 154. Thus, all the generating units (including the slack unit) are set with discrete set-points, and the remaining fractional power {P_{D}} required by customers and end-users is satisfied by 157.

From FIG. 13, FIG. 14, and FIG. 15, the fractional power {P_{D}} is always less than the slicing resolution (SR); i.e., {P_{D}}<ΔPᵢ. Thus, the error associated with the optimal power settings is too small and can be ignored without having any considerable effect on the global optimal solution.

Artificial intelligence (AI) algorithms, such as artificial neural networks (ANNs), support vector machines (SVMs), and fuzzy systems (FSs) can be employed to accelerate finding the global optimal power settings from this invention. For example, finding the discrete settings of n generating units from SFCC based on every possible discrete load demand P_{D}. Thus, ANNs can be trained based on an input matrix of all the possible discrete settings of these n units, and an output array of all the possible discrete load demands.

By combining any one of the approaches shown in FIG. 13, FIG. 14, and FIG. 15 with the SFCC unit that is solely covered for discrete load demands, a look-up table can also be created to accelerate finding the best solution for all the possible discrete load demands within very short times, where the remaining fractional power {P_{D}} can be covered by involving any one of the three preceding approaches.

1. An optimization-free economic load dispatcher (OFELD), comprising:
a starting-up stage that contains a database of all possible solutions to every discrete load demand, a detection stage that separates all the solutions that do not match with said discrete load demand, a filtration stage that rejects all the solutions that do not pass any one of the design constraints, a sorting stage that arranges all the feasible or filtrated solutions from the best to the worst, and a displaying stage that shows the best economic load dispatch solutions.
wherein the dataset of said database is created based on a realistic arrangement of power stations and how they are practically connected to the power grid.
wherein said economic load dispatch problem of said realistic arrangement of power stations is split into two levels global dispatcher and many local dispatchers.
wherein said global dispatcher is responsible to minimize the power losses in the network and select the optimal settings of all the power stations.
wherein the number of said local dispatchers is equal to the number of power stations connected to the power grid, and each one of these dispatchers is responsible to satisfy the optimal setting found from said global dispatcher with the lowest possible operating cost of its corresponding power station.
all possible settings of each generating machine of all power stations are created by slicing the continuous readings of its input power variable and output fuel-cost variable to have two vectors for each generating machine.
The total number of solutions depends on the step-size or slicing resolution, which is a proportional relationship.

2. The process of said discrete load demand can also be applied to solve non-discrete load demands by applying three approaches.
wherein the first approach is done by sharing the remaining fractional part of said non-discrete load demands by all the generating machines.
wherein the second approach is done by covering the remaining fractional part of said non-discrete load demands by the slack or biggest generating machine.
wherein the third approach is done by covering the remaining fractional part of said non-discrete load demands by a one or group of energy storage elements.

3. Artificial intelligence (AI) algorithms and others can also be employed to accelerate finding the global optimal power settings.
wherein artificial neural networks (ANNs) and support vector machines (SVMs), for example, can be used to make a relationship between the input matrix of all the possible discrete settings of generating machines and the output array of all the possible discrete load demands.
wherein fuzzy systems (FSs) can be employed to minimize the error due to uncertainty of vagueness, fuzziness, and subjective judgements of experts and power engineers.
wherein a look-up table can be created to accelerate finding the best generators' settings for all the possible discrete load demands within very short times, where the fractional parts of non-discrete load demands can also be satisfied by applying any one of the preceding three approaches listed in claim 2.
